(19) United States
(12) Patent Application Publication
(10) Pub. No.: US 2024/0183801 A1
(43) Pub. Date: Jun. 6, 2024

(54) NONDESTRUCTIVE INSPECTING DEVICE

(71) Applicants: TOPCON CORPORATION, Itabashi-ku, Tokyo (JP); RIKEN, Wako-shi, Saitama (JP)

(72) Inventors: Shigenori NAGANO, Itabashi-ku, Tokyo (JP); Satoshi YANOBE, Itabashi-ku, Tokyo (JP); Akira YAJIMA, Itabashi-ku, Tokyo (JP); Hanako AIKOH, Itabashi-ku, Tokyo (JP); Satoru ISHIGURO, Itabashi-ku, Tokyo (JP); Yoshie OTAKE, Wako-Shi, Saitama (JP); Yasuo WAKABAYASHI, Wako-Shi, Saitama (JP); Masato TAKAMURA, Wako-Shi, Saitama (JP)

(73) Assignees: TOPCON CORPORATION, Itabashi-ku, Tokyo (JP); RIKEN, Wako-shi, Saitama (JP)

(21) Appl. No.: 18/553,283

(22) PCT Filed: Mar. 31, 2022
(86) PCT No.: PCT/JP2022/016741

§ 371 Date: Sep. 29, 2023

(30) Foreign Application Priority Data
Mar. 31, 2021 (JP) 2021-059665

(51) Int. Cl. G01N 23/00; G01N 23/22

(52) U.S. Cl. CPC G01N 23/005; G01N 23/22; G01N 2223/204

(57) ABSTRACT

A nondestructive inspecting device 1 is provided with: a neutron beam emitting unit 10 capable of emitting a neutron beam in a prescribed emission direction D1; a gamma ray detecting unit 20 capable of detecting a gamma ray incident from a prescribed detection direction D2 intersecting the emission direction D1; a device housing 30 which covers the neutron beam emitting unit 10 and the gamma ray detecting unit 20, and in which an opening portion 30a is formed in the emission direction D1 and the detection direction D2; an outer shutter 31 for opening and closing the opening portion 30a of the device housing 30; an external dose monitor 41 for detecting a radiation dose inside the device housing 30; an internal dose monitor 42 for detecting a radiation dose outside the device housing 30; and a control unit 40 for prohibiting opening of the outer shutter 31 if the radiation dose detected by at least either of the dose monitors 41, 42 exceeds a predetermined threshold.

### BACKGROUND

The present disclosure relates to a non-destructive inspection apparatus for an inspection object, using neutron beams.

### BACKGROUND ART

In recent years, there has been a desire to appropriately maintain, repair, or renew aging infrastructure (hereinafter, referred to as infrastructure constructions) such as roads, bridges, tunnels, and building structures.

To inspect such an infrastructure construction, non-destructive inspection is performed using radiation, such as X-rays, penetrating an object. This non-destructive inspection allows an internal structure of an inspection object to be analyzed without destroying the inspection object.

In particular, in recent years, non-destructive inspection apparatuses performing non-destructive inspection using neutron beams with higher penetrating power than X-rays have also been studied. For example, Patent Document 1 and Non-Patent Document 1 each disclose a nondestructive inspection method that enables to provide a salt concentration distribution inside concrete, utilizing neutron beams and gamma (γ)-rays generated in reaction with the neutron beams.

### CITATION LIST

### Patent Documents

PATENT DOCUMENT 1: Japanese Unexamined Patent Publication No. 2011-85481.

### Non Patent Literature

Non-Patent Document 1: Yasuo Wakabayashi, Yuichi Yoshimura, Maki Mizuta, Yujiro Ikeda, Yoshie Otake/Riken, Non-Destructive Measurement Technique for Salt Distribution in Concrete by Neutron-Captured Prompt Gamma-Ray Analysis, Inspection Engineering February 2019, JAPAN INDUSTRIAL PUBLISHING (NPGA).

### SUMMARY OF THE INVENTION

### Technical Problems

In the technique using neutron beams as in Patent Document 1 and Non-Patent Document 1, there is a need to take safety measures, such as reduction in radioactive exposure of an inspector at a site and people around him/her, management of the exposure dose, and reduction in the misuse or abuse of devices with radiation sources by other people.

The present disclosure was made to solve such problems. It is an objective to provide a non-destructive inspection apparatus that allows inspection, while ensuring the safety of the surroundings in non-destructive inspection for an inspection object, using neutron beams.

### Solution to the Problems

In order to achieve the above objective, a non-destructive inspection apparatus of the present disclosure includes: a neutron emission unit capable of emitting a neutron beam along a predetermined emission line; a radioactive-ray detector capable of detecting a radioactive ray incident along a predetermined detection line intersecting the emission line; a first case covering the neutron emission unit and the radioactive-ray detector, and including a first opening on paths of the emission line and the detection line; a first shutter configured to open and close the first opening of the first case; a first dose detector configured to detect a radioactive dose outside the first case; a second dose detector configured to detect a radioactive dose inside the first case; and a controller configured to prohibit opening of the first shutter, when the radioactive dose detected by at least one of the first dose detector or the second dose detector exceeds a predetermined threshold.

In the non-destructive inspection apparatus described above, the controller may perform control to open the first shutter at a time of inspection under a condition that neither of the radioactive doses detected by the first dose detector and the second dose detector exceeds the predetermined threshold.

In the non-destructive inspection apparatus described above, the neutron emission unit may include: a neutron source configured to emit the neutron beam; a second case covering the neutron source, and including a second opening on the path of the emission line; a second shutter configured to open and close the second opening; and a third dose detector configured to detect a radioactive dose inside the second case. The controller may prohibit opening of the first shutter and the second shutter, when the radioactive dose detected by at least one of the first dose detector, the second dose detector, or the third dose detector exceeds a predetermined threshold.

In the non-destructive inspection apparatus described above, the controller may perform control to open the first shutter and the second shutter at a time of inspection under a condition that none of the radioactive doses detected by the first dose detector, the second dose detector, and the third dose detector exceeds the predetermined threshold.

In the non-destructive inspection apparatus described above, the controller may perform control at the time of inspection to open the first shutter prior to the second shutter at a time of inspection and cause the radioactive-ray detector to detect a radiation condition as of before the emission of the neutron beam, and then open the second shutter.

In the non-destructive inspection apparatus described above, the neutron emission unit may include: a linear accelerator capable of emitting a charged particle beam accelerated; and a target section capable of generating the neutron beam when being irradiated with the charged particle beam. The controller may prohibit the emission of the charged particle beam from the linear accelerator and the opening of the first shutter, when the radioactive dose detected by at least one of the first dose detector or the second dose detector exceeds a predetermined threshold.

In the non-destructive inspection apparatus described above, the controller may perform control to open the first shutter and emit a charged particle beam from the linear accelerator at a time of inspection under a condition that neither of the radioactive doses detected by the first dose detector and the second dose detector exceeds the predetermined threshold.

In the non-destructive inspection apparatus described above, the controller may perform control at the time of inspection to open the first shutter before the emission of the charged particle beam from the linear accelerator and cause the radioactive-ray detector to detect a radiation condition as of before the emission of the neutron beam, and then emit the charged particle beam from the linear accelerator.

### Advantages of the Invention

The present disclosure using the means described above allows for non-destructive inspection for an inspection object, using neutron beams, while ensuring the safety of the surroundings.

### BRIEF DESCRIPTION OF THE DRAWINGS

FIG. 1 is a schematic configuration diagram illustrating a non-destructive inspection system of a first embodiment of the present disclosure.

FIG. 2 is a schematic configuration diagram illustrating a non-destructive inspection system of a second embodiment of the present disclosure.

### DETAILED DESCRIPTION

Embodiments of the present disclosure will be described below with reference to the drawings.

### First Embodiment

A first embodiment of the present disclosure will be described below.

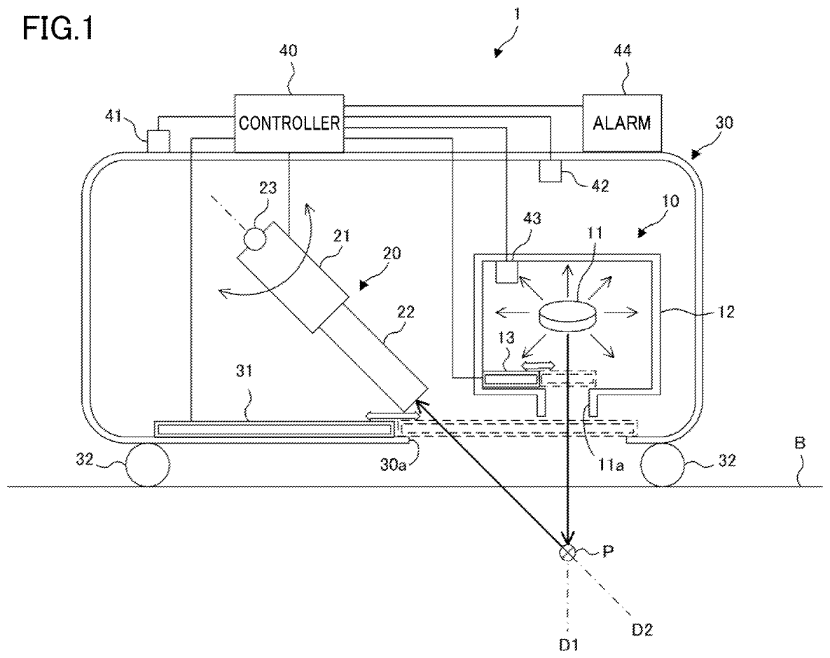

FIG. 1 is a schematic configuration diagram of a non-destructive inspection apparatus 1 of the first embodiment of the present disclosure. The configuration of the non-destructive inspection apparatus of this embodiment will now be described with reference to this figure.

As shown in FIG. 1, the non-destructive inspection apparatus 1 of this embodiment includes a neutron emission unit 10 and a gamma-ray detector (i.e., the radioactive-ray detector) 20 in an apparatus case (i.e., the first case) 30. The non-destructive inspection apparatus 1 includes a controller 40. The controller 40 is connected to an outside dose monitor (i.e., the first dose detector) 41, an inside dose monitor (i.e., the second dose detector) 42, a source dose monitor (i.e., the third dose detector) 43, all of which detect radioactive dose at the respective installation sites, and an alarm unit 44 that issues an alarm. In this embodiment, the non-destructive inspection apparatus 1 is placed on a bridge B made of concrete, which is an inspection object.

The neutron emission unit 10 includes a neutron source 11 in a source case (i.e., the second case) 12. The neutron source 11 of this embodiment is a radioisotope that spontaneously and radially generates neutron beams, and is a ²⁵²Cf source, for example.

The source case 12 is in a hollow, substantially cubic shape and includes, in the bottom surface thereof, an emission hole (i.e., the second opening) 12a for neutron beams in this embodiment. The source case 12 is also provided with a source shutter (i.e., the second shutter) 13 that opens and closes the emission hole 12a. The source case 12 and the source shutter 13 are made of a material, such as lead or iron, capable of shielding neutron beams. The emission hole 12a is a circular hole, for example. The source shutter 13 is an opening and closing plate member that slides on the bottom surface of the source case 12 so as to open and close the emission hole 12a using an actuator (not shown).

The neutron emission unit 10 with such a configuration is capable of emitting, to the outside, only the neutron beams directed downward toward the emission hole 12a among the neutron beams radially emitted from the neutron source 11. That is, in this embodiment, the neutron beams are emitted downward along an “emission line D1”. The emission and stop (non-emission) of the neutron beams can be controlled by opening and closing the source shutter 13.

The gamma-ray detector 20 includes a detector 21 capable of detecting gamma (γ-) rays, a collimator 22, and a movable shaft 23.

The detector 21 is a germanium semiconductor detector (i.e., a Ge detector), for example. The collimator 22 is connected to the top of the detector 21 capable of detecting the dose of the gamma rays incident via the collimator 22.

The collimator 22 is a cylindrical body made of a material, such as lead or iron, which blocks gamma rays and functions to narrow the gamma rays incident from outside into the gamma ray in one direction toward the detector 21. That is, in this embodiment, the axis of the collimator 22 extends along a detection line D2 of the gamma ray. As shown in FIG. 1, the detection line D2 intersects the emission line D1 at one point. This intersection serves as an inspection point P inside the bridge B as the inspection object. With a higher salt concentration at this inspection point P of inspection, a higher gamma dose than usual is detected by the detector 21.

The movable shaft 23 extends horizontally at the rear end of the detector 21. The detector 21 is capable of swinging vertically about the movable shaft 23, together with the collimator 22. This swing of the detector 21 about the movable shaft 23 makes the inspection point P movable on the emission line D1.

The apparatus case 30 covers the neutron emission unit 10 and the gamma-ray detector 20, and includes an opening (i.e., the first opening) 30a on the paths of the emission line D1 and the detection line D2.

Specifically, the apparatus case 30 is in a hollow, substantially rectangular parallelepiped shape, and made of a material, such as lead or iron, capable of shielding neutron beams. The apparatus case 30 contains the neutron emission unit 10 on one horizontal side, and the gamma-ray detector 20 on the other horizontal side.

The apparatus case 30 includes, in the bottom surface thereof, the opening 30a on the paths of the emission line D1 and the detection line D2. The shape of the opening 30a is not particularly limited as long as the opening covers the emission line D1 and the detection line D2. For example, the opening is a rectangular hole in this embodiment. Note that the opening range of the opening 30a is designed to include the range of changing the detection line D2 by the swing of the gamma-ray detector 20 about the movable shaft 23.

The apparatus case 30 includes, on the bottom surface thereof, an outer shutter (i.e., the first shutter) 31 that opens and closes the opening 30a. The outer shutter 31 is made of a material, such as lead or iron, capable of shielding neutron beams. The outer shutter 31 is a plate member that slides on the bottom surface of the apparatus case 30 so as to open and close the opening 30a using an actuator (not shown).

The apparatus case 30 includes wheels 32 outside the bottom surface thereof and is freely movable on the bridge B. In this embodiment, the apparatus case 30 directly includes the wheels 32. Alternatively, the apparatus case 30 without any wheels may be placed on a cart or a moving object so as to be movable.

In this embodiment, the apparatus case 30 is, outside the top surface thereof, provided with the outside dose monitor 41 which detects the radioactive dose around the outside of the non-destructive inspection apparatus 1. In addition, the apparatus case 30 is, inside the top surface thereof, provided with the inside dose monitor 42 which detects the radioactive dose inside the non-destructive inspection apparatus 1. The source case 12 includes, inside the top surface thereof, the source dose monitor 43 which detects the radioactive dose inside the source case 12.

Examples of the radioactive rays detectable by the dose monitors 41, 42, and 43 include alpha (α-) rays, beta (β-) rays, and gamma (γ-) rays. In addition, the dose monitors 41, 42, and 43 is each capable of detecting a spatial dose rate (e.g., microsievert per hour (μSv/h)) as the radioactive dose. Note that the type of detectable radioactive rays and the radioactive dose are not limited thereto, as long as the exposure dose to a human body is detectable.

The alarm unit 44 is provided outside the top surface of the apparatus case 30, and functions to issue an alarm to the surroundings of the non-destructive inspection apparatus 1. Examples of the alarm by the alarm unit 44 include emitting an alarm sound, emitting a sound indicating a danger, lighting or blinking an alarm lamp, or displaying a message. The alarm unit 44 not only issues an alarm but may also instruct an inspector and other people to take an action after the alarm or display the reason for the alarm. Examples of the action after the alarm include evacuation and an evacuation advisory to the surroundings.

The controller 40 is a dedicated computer or a general-purpose computer with installed software, for example. Although not shown, the controller 40 includes, for example, a calculation unit for calculation processing, a storage unit capable of storing information, such as the gamma dose detected by the gamma-ray detector 20 and the radioactive dose detected by each of the dose monitors 41, 42, and 43, a display unit capable of displaying the results of calculation, for example, an input unit that receives operations, for example, from the outside, and a communication unit capable of exchanging information with the outside.

The controller 40 is electrically connected to the dose monitors 41, 42, and 43, the source shutter 13, the outer shutter 31, and the alarm unit 44. The controller 40 is capable of executing at least control related to the safety (hereinafter referred to as “safety control”) and control related to inspection (hereinafter referred to as “inspection control”) in the non-destructive inspection apparatus 1.

In the safety control, the controller 40 controls the source shutter 13, the outer shutter 31, and the alarm unit 44 in accordance with the radioactive doses detected by the dose monitors 41, 42, and 43.

Specifically, the controller 40 acquires the radioactive doses detected by the dose monitors 41, 42, and 43. When any of the radioactive doses exceeds a predetermined threshold, the controller 40 prohibits the opening of the source shutter 13 and the outer shutter 31 and causes the alarm unit 44 to issue an alarm. As described above, at this time, the alarm unit 44 not only issues the alarm but may also instruct people to take an action after the alarm or display the reason for the alarm.

This threshold is set for each of the dose monitors 41, 42, and 43. In this embodiment, a first threshold T1 is set for the outside dose monitor 41. A second threshold T2 is set for the inside dose monitor 42. A third threshold T3 is set for the source dose monitor 43. In particular, the first threshold T1 is set to a value associated with the exposure dose to the human body. A dose monitor closer to the neutron source 11 usually has a higher radioactive dose. A higher value is thus set for the threshold of a dose monitor closer to the neutron source 11. That is, the first, second, and third thresholds T1, T2, and T3 are set in the ascending order (T1<T2<T3).

The radioactive dose increases at the occurrence of an anomaly in the non-destructive inspection apparatus 1 or activation of the apparatus itself due to long-term use. Thus, the controller 40 monitors the radioactive doses detected by the dose monitors 41, 42, and 43. When any of the radioactive doses exceeds the associated threshold T1, T2, or T3, the controller 40 prohibits the opening of (i.e., locks) the source shutter 13 and the outer shutter 31 and issues an alarm to ensure the safety.

In the inspection control, the controller 40 mainly controls the source shutter 13, the outer shutter 31, and the gamma-ray detector 20. Specifically, the controller 40 opens the outer shutter 31 and the source shutter 13 at the time of inspection under the condition that none of the radioactive doses detected by the dose monitors exceeds the predetermined threshold.

In particular, at the time of inspection, the controller 40 opens the outer shutter 31 prior to the source shutter 13. More specifically, the controller 40 opens the outer shutter 31 and causes the gamma-ray detector 20 to detect the gamma dose as of before the emission of the neutron beams, and then opens the source shutter 13 and emits neutron beams for inspection.

The controller 40 conducts the inspection under the inspection control with the safety ensured under the safety control. The inspection of this embodiment is as follows. The gamma-ray detector 20 detects the gamma rays generated in reaction with the neutron beam emitted from the neutron emission unit 10 to the inspection object. The amount of chlorine (i.e., the salt concentration) at the inspection point P is analyzed based on the gamma dose detected. Any typically known method may be employed to analyze the salt concentration in a specific inspection object. For example, collimation or gamma-ray intensity comparison described in Non-Patent Document 1 is employed.

As described above, in the non-destructive inspection apparatus 1 of this embodiment, the apparatus case 30 covers the neutron emission unit 10 and the gamma-ray detector 20, and the dose monitors 41, 42, and 43 are provided inside and outside the apparatus case 30 and inside the source case 12 to monitor the radioactive doses. That is, the exposure dose to the outside of the apparatus and the activation of the apparatus itself due to long-term use can be monitored.

The controller 40 prohibits the opening of the source shutter 13 or the outer shutter 31, when the radioactive dose detected by at least one of the dose monitor 41, 42, or 43 exceeds the predetermined threshold. This allows for less neutron beams released from the neutron emission unit 10 to the outside of the apparatus case 30 and for a lower exposure dose to the surroundings. At the same time, the alarm issued by the alarm unit 44 is capable of alerting the people around the inspector.

The controller 40 then performs control to open the source shutter 13 and the outer shutter 31 at the time of inspection under the condition that none of the radioactive doses detected by the dose monitors 41, 42, and 43 exceeds the predetermined threshold. This allows for inspection with the safety ensured.

In particular, at the time of inspection, the controller 40 performs controls to open the outer shutter 31 and cause the gamma-ray detector 20 to detect the gamma dose as of before the emission of the neutron beams, and then open the source shutter 13. The gamma-ray detector 20 is provided together with the neutron emission unit 10 in the apparatus case 30. Thus, if the source shutter 13 of the neutron emission unit 10 is opened at the same time as or prior to the outer shutter 31 at the time of inspection, the gamma-ray detector 20 may conduct inspection based on the gamma dose inside the apparatus case 30. To address the problem, at the time of inspection, the controller 40 opens the outer shutter 31 prior to the source shutter 13 and causes the gamma-ray detector 20 to detect the gamma dose outside the apparatus case 30, and then opens the source shutter 13. This allows for accurate detection of the gamma dose, that is, an improvement in the inspection accuracy. Assume that the controller 40 opens the outer shutter 31 and fails to cause the gamma-ray detector 20 to normally detect the gamma dose as of before the emission of the neutron beams. In this case, stop of the inspection at this time point allows for reduction in the exposure to the unnecessarily emitted neutron beams, which enables to further ensure the safety.

### Second Embodiment

A second embodiment of the present disclosure will be described below.

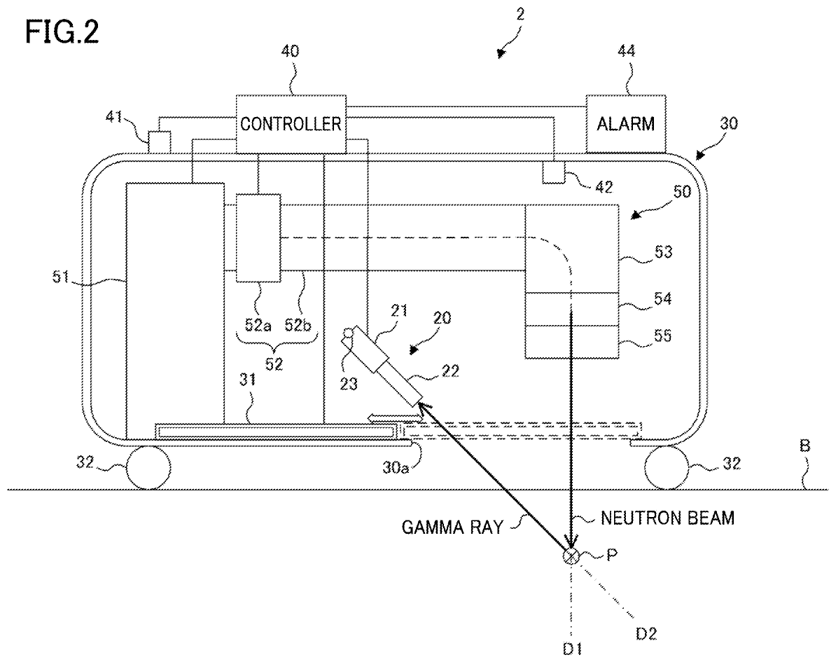

FIG. 2 is a schematic configuration diagram of a non-destructive inspection apparatus 2 of the second embodiment of the present disclosure. A configuration of the non-destructive inspection apparatus 2 of this embodiment will now be described with reference to this figure. The same reference characters are used to represent the same components as those in the first embodiment, and a description thereof is omitted.

Unlike the neutron emission unit 10 of the first embodiment using the neutron source 11, a neutron emission unit 50 of the second embodiment uses a linear accelerator 52. In addition, the non-destructive inspection apparatus 2 of the second embodiment includes no source dose monitor.

The neutron emission unit 50 includes a power supply unit 51, the linear accelerator 52 that emits proton beams as charged particle beams, a deflection unit 53, a target section 54, and an emission collimator 55.

Specifically, the power supply unit 51 is a generator that supplies electric power to units. In one preferred embodiment, the generator of the power supply unit 51 has a power generation performance to enable generation of at least protons that are charged particles, generates small voltage fluctuations, and is resistant to harmonic current. The power supply unit 51 may include a battery capable of storing electric power generated by the generator.

The linear accelerator 52 has an ion source 52a that generates protons, and is connected to the deflection unit 53 from the ion source 52a via a cylindrical acceleration unit 52b. The acceleration unit 52b accelerates the protons generated in the ion source 52a and emits the protons, as a proton beam, to the deflection unit 53.

The deflection unit 53 deflects, with magnetic force, the proton beam emitted from the linear accelerator 52 substantially perpendicularly to the direction of incidence of the proton beam, and emits the deflected proton beam toward the target section 54. The deflection unit 53 includes, for example, two magnets facing each other with a magnetic field therebetween. The magnets are electromagnets. Control of the electric current flowing through these electromagnets allows the magnetic field with a predetermined magnetic flux density to be formed between these magnets. The magnets may be permanent magnets as long as an adequately high magnetic flux density can be provided.

The target section 54 collides with protons to generate neutron beams, and contains beryllium, for example. Connected to the target section 54 is the emission collimator 55 that selects the neutron beams in a predetermined direction out of the neutron beams generated at the target section. The emission collimator 55 is capable of enhancing the directivity of the neutron beams to be emitted. The emission line D1 of the neutron beams extends downward from the apparatus as in the first embodiment. The path from the linear accelerator 52 to the target section 54 has a structure capable of maintaining high vacuum not to prevent the charged particles from flying.

The neutron emission unit 50 with such a configuration is electrically connected to a controller 60. The controller 60 is capable of causing the neutron emission unit 50 to emit neutron beams at any time by controlling the time of emitting protons from the ion source 52a.

The controller 60 of the second embodiment is electrically connected to the outside dose monitor 41, the inside dose monitor 42, the outer shutter 31, and the alarm unit 44 in addition to the neutron emission unit 50. The controller 60 is capable of executing control related to the safety (hereinafter referred to as “safety control”) and control related to inspection (hereinafter referred to as “inspection control”) in the non-destructive inspection apparatus 2.

In the safety control, the controller 60 controls the ion source 52a, the outer shutter 31, and the alarm unit 44 in accordance with to the radioactive doses detected by the dose monitors 41 and 42.

Specifically, the controller 60 acquires the radioactive doses detected by the dose monitors 41 and 42. When any of the radioactive doses exceeds a predetermined threshold, the controller 40 prohibits the emission of protons from the ion source 52a and the opening of the outer shutter 31 and causes the alarm unit 44 to issue an alarm. The predetermined threshold is the same as in the first embodiment, and a description thereof will be omitted.

In the inspection control, the controller 60 mainly controls the ion source 52a, the outer shutter 31, and the gamma-ray detector 20. Specifically, the controller 60 opens the outer shutter 31 and causes the ion source 52a to emit protons at the time of inspection under the condition that none of the radioactive doses detected by the dose monitors 41 and 42 exceeds the predetermined threshold.

In particular, at the time of inspection, the controller 60 opens the outer shutter 31 before the ion source 52a emits protons. More specifically, the controller 60 opens the outer shutter 31 and causes the gamma-ray detector 20 to detect the gamma dose as of before the emission of the neutron beams, and then causes the ion source 52a to emit protons. The other aspects of the inspection method are the same as in the first embodiment, and a description thereof will be omitted.

As described above, in the non-destructive inspection apparatus 2 of the second embodiment, the apparatus case 30 covers the neutron emission unit 50 and the gamma-ray detector 20, and the dose monitors 41 and 42 are provided inside and outside the apparatus case 30 to monitor the radioactive doses. That is, the exposure dose to the outside of the apparatus and the activation of the apparatus itself due to long-term use can be monitored.

The controller 60 prohibits the generation of protons by the ion source 52a and the opening of the outer shutter 31, when the radioactive dose detected by at least one of the dose monitor 41 or 42 exceeds the predetermined threshold. This allows for less neutron beams released from the neutron emission unit 10 to the outside of the apparatus case 30 and for a lower exposure dose to the surroundings. At the same time, the alarm issued by the alarm unit 44 is capable of alerting the people around the inspector.

The controller 60 then opens the outer shutter 31 and causes the ion source 52a to emit protons at the time of inspection under the condition that none of the radioactive doses detected by the dose monitors 41 and 42 exceeds the predetermined threshold. This allows for inspection with the safety ensured.

In particular, at the time of inspection, the controller 60 performs control to open the outer shutter 31 and causes the gamma-ray detector 20 to detect the gamma dose as of before the emission of the neutron beams, and then cause the ion source 52a to emit protons. The gamma-ray detector 20 is provided together with the neutron emission unit 10 in the apparatus case 30. Thus, if the ion source 52a of the neutron emission unit 10 generates protons at the same time as or before the opening of the outer shutter 31 at the time of inspection, the gamma-ray detector 20 may conduct inspection based on the gamma dose inside the apparatus case 30. To address the problem, at the time of inspection, the controller 60 opens the outer shutter 31 before the emission of the protons by the ion source 52a and causes the gamma-ray detector 20 to detect the gamma dose outside the apparatus case 30, and then causes the ion source 52a to emit protons. This allows for accurate detection of the gamma dose, that is, an improvement in the inspection accuracy. Assume that the controller 40 opens the outer shutter 31 and fails to cause the gamma-ray detector 20 to normally detect the gamma dose as of before the emission of the neutron beams. In this case, stop of the inspection at this time point allows for reduction in the exposure to the unnecessarily emitted neutron beams, which enables to further ensure the safety.

The embodiments of the present disclosure have been described above. The present disclosure is however not limited to the embodiments described above.

While the bridge B has been described as the inspection object in the embodiments described above, the inspection object is not limited thereto. For example, applicable as the inspection object is a road, a wall of a building or a tunnel, a column, or any other concrete structure.

While the emission line of the neutron beams extends downward from the apparatus in the embodiments described above, the emission line of the neutron beams is not limited thereto. For example, if the inspection object is a wall or a column, the neutron beams are emitted horizontally in one preferred embodiment. In such a case, the apparatus case may have an opening in a side surface thereof.

The neutron beams are not necessarily emitted in one direction but may be emitted in a plurality of directions. For example, the apparatus case may have openings in the bottom surface and a side surface to emit the neutron beams downward and horizontally in a switchable manner in accordance with the inspection object.

While the non-destructive inspection apparatuses of the embodiments described above each include only one gamma-ray detector, the number of the gamma-ray detectors is not limited to one. If containable in the apparatus case, each non-destructive inspection apparatus may include two or more gamma-ray detectors.

While the gamma rays are detected by the gamma-ray detector for analysis of the salt concentration distribution in the embodiments described above, but the radioactive rays to be detected are not limited to the gamma rays. For example, each non-destructive inspection apparatus may detect thermal neutrons, which are generated from an inspection object irradiated with neutron beams, to detect voids and water in the inspection object.

In the embodiments described above, the opening of the source shutter 13 and the outer shutter 31 is prohibited and an alarm is issued by the alarm unit 44, when a predetermined threshold is exceeded. Another threshold may be set. For example, in the configuration of the first embodiment described above, the radioactive dose detected by the source dose monitor 43 also correlates with the energy of the neutron beams emitted by the neutron source 11. Accordingly, the controller 40 may set a fourth threshold T4. When the radioactive dose detected by the source dose monitor 43 exceeds the fourth threshold, the controller 40 may also prohibit the opening of the source shutter 13 and the outer shutter 31 and cause the alarm unit 44 to issue an alarm. This enables to reduce a decrease in the inspection accuracy due to the energy shortage in the neutron source 11 and reduces unnecessary inspection. This configuration also enables to inform an inspector or other people of the time of replacing the neutron source.

### DESCRIPTION OF REFERENCE CHARACTERS

1, 2 Non-Destructive Inspection Apparatus
10, 50 Neutron Emission Unit
10a Emission Hole (Second Opening)
11 Neutron Source
12 Source Case (Second Case)
13 Source Shutter (Second Shutter)
20 Gamma-Ray Detector (Radioactive-Ray Detector)
21 Detector
22 Collimator
23 Movable Shaft
30 Apparatus Case (First Case)
30a Opening (First Opening)
31 Outer Shutter (First Shutter)
32 Wheel
40, 60 Controller
41 Outside Dose Monitor (First Dose Detector)
42 Inside Dose Monitor (Second Dose Detector)
43 Source Dose Monitor (Third Dose Detector)
44 Alarm unit
51 Power Supply Unit
52 Linear Accelerator
52a Ion Source
52b Acceleration Unit
53 Deflection Unit
54 Target Section
55 Emission Collimator

1. A non-destructive inspection apparatus comprising:
a neutron emission unit capable of emitting a neutron beam along a predetermined emission line;
a radioactive-ray detector capable of detecting a radioactive ray incident in a predetermined detection line intersecting the emission line;
a first case covering the neutron emission unit and the radioactive-ray detector, and including a first opening on paths of the emission line and the detection line;
a first shutter configured to open and close the first opening of the first case;
a first dose detector configured to detect a radioactive dose outside the first case;
a second dose detector configured to detect a radioactive dose inside the first case; and
a controller configured to prohibit opening of the first shutter, when the radioactive dose detected by at least one of the first dose detector or the second dose detector exceeds a predetermined threshold.

2. The non-destructive inspection apparatus of claim 1, wherein
the controller performs control to open the first shutter at a time of inspection under a condition that neither of the radioactive doses detected by the first dose detector and the second dose detector exceeds the predetermined threshold.

3. The non-destructive inspection apparatus of claim 1, wherein
the neutron emission unit includes:
a neutron source configured to emit the neutron beam;
a second case covering the neutron source, and including a second opening on the path of the emission line;
a second shutter configured to open and close the second opening; and
a third dose detector configured to detect a radioactive dose inside the second case, wherein
the controller prohibits opening of the first shutter and the second shutter, when the radioactive dose detected by at least one of the first dose detector, the second dose detector, or the third dose detector exceeds a predetermined threshold.

4. The non-destructive inspection apparatus of claim 3, wherein
the controller performs control to open the first shutter and the second shutter at a time of inspection under a condition that none of the radioactive doses detected by the first dose detector, the second dose detector, and the third dose detector exceeds the predetermined threshold.

5. The non-destructive inspection apparatus of claim 4, wherein
the controller performs control to open the first shutter prior to the second shutter at a time of inspection and cause the radioactive-ray detector to detect a radiation condition as of before the emission of the neutron beam, and then open the second shutter.

6. The non-destructive inspection apparatus of claim 1, wherein
the neutron emission unit includes:
a linear accelerator capable of emitting a charged particle beam accelerated; and
a target section capable of generating the neutron beam when being irradiated with the charged particle beam, and
the controller prohibits the emission of the charged particle beam from the linear accelerator and the opening of the first shutter, when the radioactive dose detected by at least one of the first dose detector or the second dose detector exceeds a predetermined threshold.

7. The non-destructive inspection apparatus of claim 6, wherein
the controller performs control to open the first shutter and emit a charged particle beam from the linear accelerator at a time of inspection under a condition that neither of the radioactive doses detected by the first dose detector and the second dose detector exceeds the predetermined threshold.

8. The non-destructive inspection apparatus of claim 7, wherein
the controller performs control at the time of inspection to open the first shutter before the emission of the charged particle beam from the linear accelerator and cause the radioactive-ray detector to detect a radiation condition as of before the emission of the neutron beam, and then emit the charged particle beam from the linear accelerator.
